(19) United States
(12) Patent Application Publication
(10) Pub. No.: US 2014/0060688 A1
(43) Pub. Date: Mar. 6, 2014

(54) MEDIA SEPARATING DEVICE, IN PARTICULAR HYDRAULIC ACCUMULATOR, INCLUDING ASSOCIATED MEASURING APPARATUS AND MEASURING METHOD

(71) Applicants: Matthias Leo Jirgal, Saarbrucken (DE); Horst Mannebach, Munstermaifeld (DE); Martin Groben, Sulzbach (DE)

(72) Inventors: Matthias Leo Jirgal, Saarbrucken (DE); Horst Mannebach, Munstermaifeld (DE); Martin Groben, Sulzbach (DE)

(73) Assignee: HYDAC TECHNOLOGY GMBH, Sulzbach/Saar (DE)

(21) Appl. No.: 13/261,771

(22) PCT Filed: Apr. 7, 2012
(86) PCT No.: PCT/EP2012/001559

§ 371 Date: Nov. 4, 2013

(30) Foreign Application Priority Data
May 5, 2011 (DE) 10 2011 100 532.7

(51) Int. Cl. F15B 1/16

(52) U.S. Cl. CPC F15B 1/165
USPC 138/30

(57) ABSTRACT

The invention relates to a media separating device (1), in particular a hydraulic accumulator (3), having a movable separating means (5) for separating two media (7, 9) which are received in media chambers (11, 13) differing from each other, wherein said media separating device is characterized in that, by means of a measuring apparatus (15, 115), it is possible to detect an overflow of at least one medium (7, 9) from a medium chamber (11, 13) via the separating means (5) into the other medium chamber (11, 13) having the other medium (9, 7).

The invention relates to a media separating means, in particular a hydraulic accumulator having a movable separating means for separating two media which are accommodated in media chambers that differ from one another. The invention also relates to a measuring apparatus, also designed as a retrofitting or conversion kit as well as a measuring method for operating the measuring apparatus in the media separating means.

Media and in particular flowable media as defined in the present invention are often used in drive technology, for example, as lubricants and/or coolants or as pressure means in hydraulic installations for transmitting energies from a pressure medium source to a consumer. Flowable media, for example, hydraulic oil or other pressurized fluids are in media separating means here, such as hydraulic accumulators, which fulfill a wide variety of functions in hydraulic installations and serve, for example, to store energy, to supply a fluid reserve, for emergency actuation of power consuming devices, pressure surge attenuation and the like. Secure and proper operation of a hydraulic installation requires not only knowledge of physical operating parameters such as pressure or flow velocities but also information about whether the media separating means itself is trouble-free and functions reliably in operation.

DE 101 52 777 A1 describes a device for determining the quality of a medium, in particular a lubricant and/or coolant, having multiple sensors which deliver an electric output signal as a function of the respective sensor-specific input variable, where one sensor is a temperature sensor, which delivers an output signal, being basically dependent only on the temperature of the medium and being basically independent of the quality of the medium in particular. Another sensor delivers an output signal which depends on the quality of the medium as well as the temperature of the medium. The sensors used are arranged on a shared substrate, which can be immersed in the respective medium to be tested. The device designed in this way permits determination of quality-determining parameters of flowable media, independently of their prevailing temperature.

DE 10 2009 010 775 A1 describes a media separating means in the form of a hydraulic accumulator for receiving at least a partial volume of a liquid under pressure, the hydraulic accumulator having a housing with at least one connection point for connecting the hydraulic accumulator to a hydraulic device such as a hydraulic circuit. A data memory is a component of the hydraulic accumulator, so that the data stored in the data memory can be electronically read out by means of a read and/or write device situated outside of the hydraulic accumulator. The operating state of the hydraulic accumulator can therefore be determined and monitored reliably and the monitoring can also be automated and controlled by a control unit.

With the known approach, an elastomer diaphragm designed as a bladder separated two media chambers from one another inside the accumulator housing serves as the separating means, the one media chamber preferably having a compressible working gas, such as nitrogen gas, as the medium, and the other media chamber being fillable with hydraulic fluid as another pressurized medium, coming from the hydraulic device, through the connection point in the accumulator housing. The filling is accomplished against the compressive force of the working gas, such that the elastomeric separating means “contracts” and moves to this extent. If hydraulic fluid is needed again on the part of the hydraulic device, the separating means “relaxes” and the required amount of fluid is discharged from the accumulator housing through the connection, under the influence of the compressive force of the working gas, but a partial amount of fluid usually remains in the accumulator. Due to the permeability of the diaphragm material, there is an unwanted transfer of the hydraulic fluid to the so-called gas side of the hydraulic accumulator in the long term, which may occur suddenly due to the development of cracks or tears, for example, in the event of failure of the separation diaphragm, with the result that the “working capacity” of the hydraulic accumulator is impaired or it may even fail completely within the hydraulic circuit, which could make operation of a hydraulic installation substantially more difficult or even impossible.

DE 40 06 905 A1 has already proposed creating a method and a device that can be used for this method for measuring the pressure of a gas, in particular for determining the gas charge pressure in a hydraulic accumulator and/or for maintaining a preselected pressure setpoint value in the container, with which an unwanted transfer of hydraulic fluid to the working gas side of the accumulator could be detectable. This approach is relatively complex and is expensive to implement with regard to the multitude of components. Thus, for a corresponding measuring method, a connection that can be used at least temporarily to exchange working gas between the hydraulic accumulator and a measuring chamber is to be established at least temporarily for a corresponding measuring method. This connection preferably has only a fraction of the container volume and also has a pressure measuring apparatus. In addition, the connection between the hydraulic accumulator and a refilling device is also established at least temporarily for maintaining the pressure setpoint value. This refilling device refills the container with gas on the working gas side when the actual pressure value in the container is lower than the setpoint pressure value.

Against the background of this prior art, the object of the present invention is to create a media separating means, in particular in the form of a hydraulic accumulator, which is capable of detecting the interference cases described above using few components and to do so inexpensively and promptly and to forward the results to the operator of the hydraulic installation to which such hydraulic accumulators are regularly connected.

These objects are achieved by the media separating means defined in claim 1 and by a measuring apparatus defined in another independent claim as well as by a measuring method for operating the measuring apparatus, which is defined in another independent claim.

According to the invention, it is provided according to the characterizing part of patent claim 1 that an overflow of at least one medium of a media chamber of the media separating means by means of the separating means can be detected by means of a measuring apparatus in the other media chamber with the other medium. With the help of the measuring apparatus it is advantageously accomplished that preferably at least the presence and optionally the type of a flowable medium can be detected easily, preferably in any design of a media separating means, as soon as at least one of the two media is inadvertently transferred from its originating media chamber to the other media chamber. The detection of media incapable of flow may serve here in particular as a prerequisite for the use of safety functions or the functionally reliable control of operating sequences, even in hydraulic installations have a complex design.

In a particularly preferred exemplary embodiment of the media separating means, the measuring apparatus has at least one sensor element, which can ascertain the overflow of media over the separating means using a thermal and/or chemical and/or physical and/or optical and/or acoustic and/or electric measuring method. The respective sensor element advantageously has a connection to a fixed location in relation to at least one of the media chambers, such that, in any assumed position of the separating means, the sensor element can be brought into contact with the medium that has overflowed. The connection is accomplished in a particularly advantageous exemplary embodiment of the media separating means by means of at least one flexible cable connection, whereby the cable is connected to the sensor element at its one end and is connected to the anchoring point using parts of an accumulator housing at its other end, said accumulator housing bordering the media chambers at least partially.

The end of the cable connection adjacent to the fixed location is connected to a plug part which preferably also comprises an electronic analyzer. A media separating means having a measuring apparatus for detection of an overflow of at least one medium of a media chamber through the separating means into the other media chamber with the other medium is created in this way in a particularly compact design that is inexpensive to manufacture.

The media separating means is designed as a hydraulic accumulator in the manner of a bladder accumulator in a preferred exemplary embodiment having a flexible bladder as the separating means. The respective sensor element is arranged on the media chamber designed as the gas side within the accumulator housing of the hydraulic accumulator. The additional media chamber of the hydraulic accumulator here forms the fluid side. Other designs of media separating means in particular in the form of hydraulic accumulators such as bellows accumulators, diaphragm accumulators or piston accumulators can fundamentally be equipped with the inventive measuring means in this regard.

It may be advantageous to design a measuring apparatus also as a retrofitting or conversion kit to be used subsequently in existing media separating means and to put it to use. The measuring apparatus designed as a retrofitting or conversion kit has at least one sensor element and a cable connection as well as an electronic analyzer and preferably a separating means. For example, if the operator of a hydraulic installation wants to improve the monitoring of the media separating means in the hydraulic installation in particular, then the existing media separating means can be modified and improved by the subsequent installation of a retrofitting or conversion kit in that regard.

A measuring method for operation of the measuring apparatus in a media separating means may advantageously be designed as a thermal measuring method, wherein the thermal conductivity of a medium in a media chamber of the media separating means is used for analysis, wherein the heating power required for a defined increase in the temperature of the medium is determined by means of a sensor element provided with at least one heating resistor. The temperature increase in the medium in the media chamber when using a defined heating power can also be determined. The use of a transient heating wire method in which a heating wire in the sensor element serves both as a heat source and as a temperature sensor is preferably suitable for this purpose. Instead of using a wire, a thin film resistor on a ceramic substrate may also be used. The thin film resistor is advantageously connected here as a branch of a wheatstone bridge. A power supply voltage to the Wheatstone bridge can be pulsed and the rise in the bridge signal, i.e., the increase in temperature can be analyzed by the analysis unit.

It may also be advantageous to design the measuring method as an optical measuring method and to determine the luminescence of the medium in the respective media chamber. An optical measuring method may also be used to advantage, wherein the attenuation and reflection properties of the respective overflow medium are used optically for the analysis.

The electric conductivity is preferably suitable as the electric measuring method in the event of inadvertent overflow of one medium into the other medium. This measuring method is suitable in particular when the media used in the media separating means do not form insulators. It may be advantageous to use the dielectric properties of the respective medium for analysis. Furthermore, it may be advantageous to use a chemical measuring method, in particular measuring methods in which at least a portion of the sensor element changes based on a chemical or physical reaction on coming in contact with the respective other medium. Such changes may include a detectable swelling or even dissolution of part of the sensor element. Color changes based on chemical reaction of the medium with a part of the sensor element may also be utilized to detect the overflow of one medium of a media chamber through the separating means into the other media chamber containing the other medium.

The present invention is explained in detail below on the basis of exemplary embodiments illustrated in the drawings, in which:

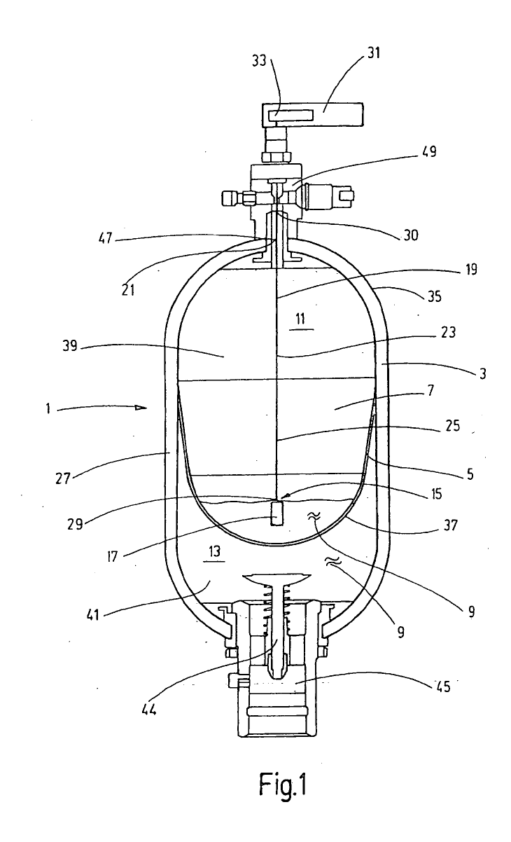

FIG. 1 shows a schematic longitudinal sectional diagram, not drawn to scale, of a media separating means in the form of a hydraulic accumulator designed as a bladder accumulator;

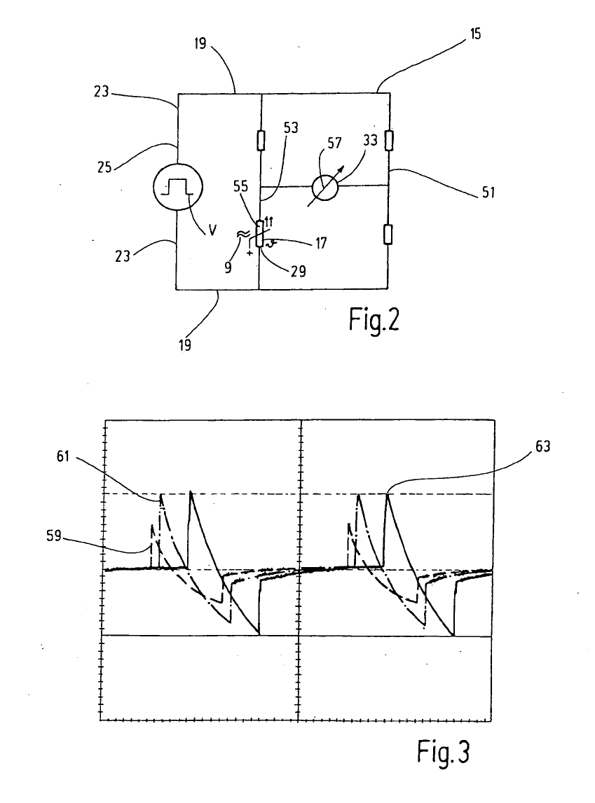

FIG. 2 shows a schematic diagram of a thermal measuring method for operation of a measuring apparatus in a media separating means;

FIG. 3 shows measurement results of a thermal conductivity measurement on admission of a gaseous medium and a liquid medium to a sensor element of the measuring apparatus;

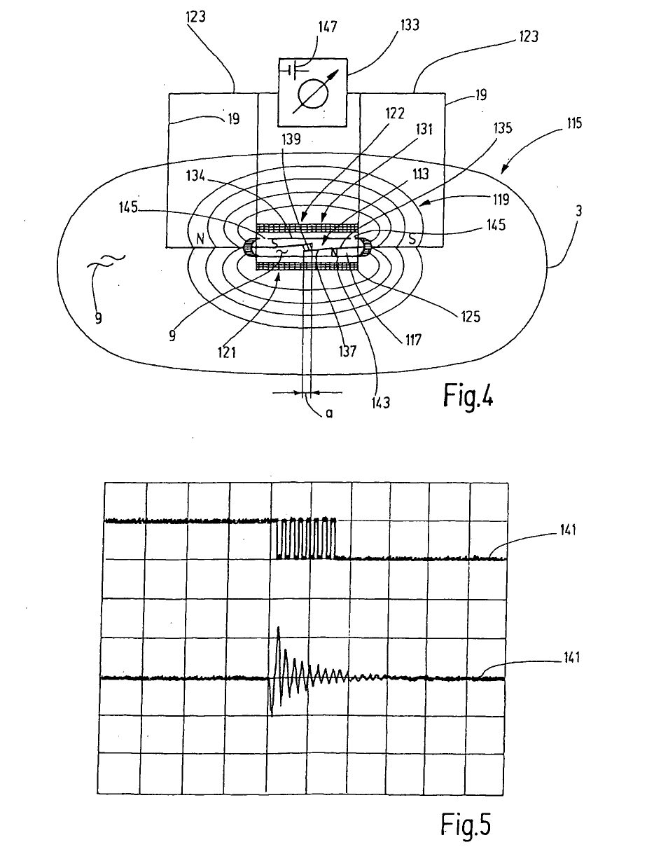

FIG. 4 shows a basic diagram of an “acoustic measuring method” for operation of a measuring apparatus in a media separating means;

FIG. 5 shows measurement results of the “acoustic measuring method” in the form of a curve of two characteristic variables of oscillation, such as those obtained in measurement operation using the apparatus according to FIG. 4.

FIG. 1 shows a media separating means 1 in the form of a hydraulic accumulator 3 having a movable separating means 5 for separating two media 7, 9. The media 7, 9 are accommodated in different media chambers 11, 13, the movable separating means 5 separating the media chambers 11, 13 from one another in a medium-tight manner. A measuring apparatus labeled as 15 on the whole serves to detect an accidental overflow of the medium 9 out of the media chamber 13 through the separating means 5 into the other media chamber 11 containing the other medium 7.

The hydraulic accumulator 3 is designed in the manner of a bladder accumulator 35 and has a flexible bladder 37 consisting of an elastomer material as the separating means 5. The hydraulic accumulator 3 serves to receive a gaseous medium 7 in the form of a working gas, in particular in the form of nitrogen gas, and to receive an additional fluid medium 9 consisting of hydraulic fluid in the present case. The media 7, 9 in this regard may readily be under a pressure of up to 600 bar or more. In the exemplary embodiment shown in FIG. 1, a sensor element 7 is arranged on the media chamber 11 designed as the gas side 39 inside an accumulator housing 27 of the hydroaccumulator 3, wherein the additional media chamber 13 inside the accumulator housing 27 forms the aforementioned fluid side 41 of the hydraulic accumulator 3. A plate valve 44 which is inserted into the fluid connecting opening 45 of the hydraulic accumulator 3 in the usual design serves to trigger the media flow on the fluid side 41 of the hydraulic accumulator 3. The hydraulic accumulator 3 can be connected in a fluid-carrying connection to additional hydraulic equipment (not shown) in the form of a hydraulic circuit or the like, for example, by way of the fluid connection opening 45 in this regard.

On the opposite side from the connection opening 45 and as seen in the direction of viewing in FIG. 1 above the accumulator housing 27 there is another connection opening 47 as part of a screw-on component 49 by which the hydraulic accumulator 3 can be filled or refilled regularly with working gas on its gas side 39. The design of hydraulic accumulators 3 in this regard is as usual and was already described in greater detail in a previous patent application (DE 10 2006 004 120 A1) by the present applicant and is also freely available on the market in a variety of embodiments so that the details need not be described further here.

Instead of the working gas on the gas side 39, a compressible foam or compressible filling bodies, such as hollow foam bodies (not shown) and the like may be used additionally or alternatively as the medium in the media chamber 11. To this extent, the medium 7 introduced then into the media chamber 11 is formed by the materials in this regard. Furthermore, FIG. 1 already illustrates the situation of a so-called bladder rupture, in which fluid 9 from the media chamber side 13 has been mixed unintentionally with the working gas 7 on the gas media chamber side 11, so that the fluid 9 has already collected on the bottom of the elastomer bladder and then can be detected via the measuring apparatus 15 with the sensor element 17 which will be described in greater detail below. In particular the measuring apparatus 15 with the sensor element 17 serves to ascertain the accidental overflow of media as described above using a thermal and/or chemical and/or physical and/or optical and/or acoustic and/or electric measuring method.

The respective sensor element 17 has a connection 19 to the accumulator housing 27 via a fixed location 21 in relation to the media chamber 11 such that in each assumed position of the separating means 5, the sensor element 17 can be brought into contact with the overflowing medium 9. In the exemplary embodiment shown in FIG. 1, the connection 19 is embodied by means of at least one flexible cable connection 23 wherein the respective cable 25 is connected at its one end 29 to the respective sensor element 17 in an electrically conducting manner and at its other end 30 is connected to parts of an electronic analyzer 33 by means of the fixed location 21 on the accumulator housing 27. The end 30 of the cable connection 23 adjacent to the fixed location 21 is connected to a plug part 31 in which the electronic analyzer 33 is integrated for analysis of measured signals of the sensor element 17.

The measuring apparatus 15, essential components of which are shown in one exemplary embodiment in FIG. 2, is designed as a retrofitting or conversion kit. The measuring apparatus 15 consisting of at least the sensor element 17, the cable connection 23, the electronic analyzer 33 and preferably the separating means 5 for use in a media separating means 1. Hydraulic accumulators that have already been supplied can be retrofitted or converted with the measuring apparatus 15 plus the electronic analyzer 33 using the retrofitting or conversion kit described here by simply exchanging the flexible accumulator bladder with a new accumulator bladder 37 into which the electronic analyzer and measuring units have been integrated. The accumulator bladder may optionally also remain in the hydraulic accumulator 3, and to this extent, only the electronic analyzer and measuring unit need be introduced additionally into the hydraulic accumulator 3.

In addition to the hydraulic bladder accumulator 3, other media separating means may also be equipped with the measuring apparatus 15. Thus the invention can also be used with piston accumulators in which the separating means 5 is formed by a piston that is sealed with respect to the wall of the accumulator housing and, by means of the sealing system of which, fluid can move inadvertently from the fluid side to the gas side of the accumulator, which is also true in the event a gasket on the piston fails completely. In particular with an embodiment in that regard, it must be ensured at any rate that the respective sensor element 17 can always detect the accidental overflow at the lowest position of the piston by means of an electric connecting cable 25, which is selected to be long enough, and can detect this in each position of the piston. The same considerations naturally also apply to the bladder accumulator mentioned above as well as applying to additional accumulator approaches, such as, for example, bellows accumulators, spring accumulators or diaphragm accumulators, in which the inventive approach may also be used to detect the accidental overflow of media.

The aforementioned electronic analyzer 33 may also have an output unit based on an electric, optical, acoustic or haptic function and situated directly on the hydraulic accumulator 3 within a type of plug part 31 in the proposed approach according to FIG. 1. However, by means of a corresponding cable connection or some other information connection, the electronic analyzer may also be arranged in a central location, for example, inside an overall control unit, which is then capable of monitoring multiple hydraulic accumulators within an overall hydraulic installation for the inadvertent overflow of media to display the failure event for the operator of the installation.

FIG. 2 shows, only as an example, a device for performing a thermal measuring method which can be performed by the measuring apparatus 15 designed for this purpose. The measuring apparatus 15 shown here is capable of detecting the change in the thermal conductivity of the medium 7 on the gas side 39 in particular on admission of the medium 9. To do so the measuring apparatus 15 has a resistance measuring bridge 51 formed in the manner of a Wheatstone bridge. The sensor element 17 designed as a heat resistor 55 is arranged in a bridge branch 53. The resistance measuring bridge 51 is supplied with a pulsed operating voltage V. At the time of activation of the power supply voltage, the resistance measuring bridge 51 is compensated. The differential voltage of the center of the bridge displayed in the display instrument 57 shown here is “0.” Due to the operating current in the heating resistor 55, its electric resistance changes so that the resistance measuring bridge 51 is “adjusted.” The resulting differential voltage corresponds to the change in the electric resistance of the heating resistor 55 and in turn the increase in temperature. The increase in temperature is characteristic of the presence of a medium to be detected, namely the medium 9 here, which has overflowed inadvertently from the media chamber 13 into the media chamber 11 due to failure of the elastomer accumulator bladder 37.

The result of this measuring method is shown in FIG. 3 on the basis of the curve of three measured values 59, 61, 63. These measured value curves show different temperature curves plotted as a function of time on the heating resistor 55. The curve of the measured value 59 with the smaller absolute temperature increases shows a measuring curve for oil as an example. The curve of the measured values 61 and 63 shows temperature increases in a working gas under a pressure of approx. 100 bar (measured curve 61) and at an ambient pressure (measured curve 63). It is directly apparent from this that significant differences in the temperature curve can be represented as a function of an aggregate state in particular (gaseous or liquid) of a respective medium. Again the presence and type of the respective medium around the sensor element 17 can be deduced on the basis of the curve of the measured values. A threshold value, which allows a differentiation of the media 7, 9 under all operating conditions of the media separating means 1, is determined here on the basis of experiments so that the inadvertent overflow of media can be detected in this way.

FIG. 4 shows a type of acoustic measuring method in greater detail in a schematic diagram based on the use of a measuring apparatus 115. The sensor element 117 has an oscillating device 113, which is excited to oscillation under the influence of a field 119 of a field generating device 121 (cf. FIG. 5). The oscillating behavior of the oscillating device 113 changes on admission of the flowable medium 9 so that the change in the oscillating behavior of the oscillating device 113 is detected by the measuring apparatus 115. In the exemplary embodiment of the measuring apparatus 115 shown in FIG. 4, the field generating device 121 is formed by a magnetic device 122. The measuring apparatus 115 also has an electromagnetic coil 125 so that the flux of the electromagnetic coil 125 and an electric voltage in the coil 125 are influenced by oscillations of the sensor element 117 excited by the electromagnetic coil 125.

As shown in FIG. 4, the field generating device 121 is combined in a single component, namely here in the form of the electromagnetic coil 125 in a particularly preferred exemplary embodiment of the measuring apparatus 115. The sensor element 117 is connected to the electronic analyzer 133, in the same way as shown in FIG. 1, by a flexible cable connection 123 as the connection 19.

The oscillating device 113 is designed in the manner of a Reed switch 131. The Reed switch 131 has two soft magnetic flexible metal tongues 134, 135 which are opposite one another in the sensor element 117 and whose ends 137, 139 overlap axially with a length a. The ends 137, 139 of the metal tongues 134, 135 do not contact one another in the exemplary embodiment shown in FIG. 4. Radially the metal tongues 134, 135 are surrounded essentially over their entire length by the magnetic device 122 formed as an electromagnetic coil 125.

When the electromagnetic coil 125 is energized, it generates the magnetic field 119, which is represented only schematically in FIG. 4, wherein the metal tongues 134, 135 move toward one another with an increase in field strength. The metal tongues 134, 135 may also touch one another depending on the field strength of the magnetic field 119. With a decline in the field strength of the magnetic device 122, the metal tongues 134, 135 become released from one another and execute free oscillations. Energization of the electromagnetic coil 125 may also be entirely interrupted to initiate the oscillation process of the metal tongues 134, 135 in this regard.

As FIG. 5 shows, an oscillation characteristic variable 141 or multiple oscillation characteristic variables can be detected here by means of the measuring apparatus 115. FIG. 5 shows two sets of curves, where the top curve shows a number of oscillations of the metal tongues 134, 135 above a predefinable threshold value of an oscillation amplitude in the direction of consideration of FIG. 5. The bottom curve in the angle of view in FIG. 5, however, shows an example of plotting the absolute oscillation amplitude of the metal tongues 134, 135 as a function of time.

Depending on which medium comes in contact with the sensor element 117, the oscillation curves according to the exemplary diagram in FIG. 5, pertaining to a WD-40 spray oil, look different. Thus the curves for air, nitrogen gas, water, various hydraulic oils and lubricating oils, cold cleaning agents such as alcohol or the like, including fuels such as diesel oil, differ substantially from one another. It is thus also possible with this sensor element 117 to detect the overflow of fluid to the gas side of the hydraulic accumulator 3.

As FIG. 4 also shows, the sensor element 117 has a sleeve 143, which is preferably formed from a mineral glass material, wherein the sleeve 143 completely encloses the metal tongues 134, 135 both radially and axially, while maintaining a minimum radial distance from the metal tongues 134, 135, so as not to have a negative effect on their excited oscillation. The sleeve 143 in this regard has two openings 145 for the media access to the respective metal tongues 134, 135.

The energy for operation of the sensor element 117 and the measuring apparatus 115 is supplied from the outside by an electric energy source 147 in the form of a battery (not shown) or preferably in a hard-wired operation in which the sensor 117 is in turn connected by a cable connection 123 in the form of the connection 19 to the electronic analyzer 133.

In addition to the measuring method described here, optical methods may also be used. Thus so-called scattered light methods are very suitable for detection of fluid mists if such a mist is to be formed on the gas side of the accumulator bladder 37. With certain media, the presence of luminescence might also be used for detection. Other optical analytical options may be seen in the reflection or attenuation properties of various liquids with respect to the passage of light through a sensor. Optical waveguides, i.e., fiber-optic cables, are preferably used when using optical measuring methods.

Furthermore, electric measuring methods, preferably based on the measurement of dielectric or conductive properties of the medium in the sense presented here, may be used. Fluids and gases can also be differentiated from one another on the basis of the dielectric constant as well as the conductivity.

Measurement systems, in which an element changes because of a chemical or physical reaction on coming in contact with the liquid to be detected, are to be used with chemical measuring methods. These changes may include the following in the case of the inadvertent transfer of media as described here:
Swelling or increase in volume of a sensor element;
Dissolving or reduction in volume of a sensor element;
Change in color of a sensor element and
Change in electric properties of a sensor element.

The separation or dissolution of the sensor element can be detected, for example, with a spring bias switch. This switch is preferably designed so that the change in volume opens or closes the switch and delivers a signal to the electronic measuring apparatus 33. Plastics are preferred as the materials for the sensor elements mentioned here. Depending on the liquid to be detected, an unstable plastic which responds to this is preferably selected.

If a polymer as a sensor element changes its color based on its contact with the fluid, this can in turn be detected by suitable measuring methods. If the polymer is embodied preferably as an absorbent nonwoven, the nonwoven can transport the fluid to the sensor element, thus forming a spatially distributed sensor and analysis system.

If the electric conductivity changes on contact with the fluid, this effect can also be used for detection. As with the electric method already mentioned, a thin film interdigital electrode structure coated with the polymer may be used, for example.

In conclusion, reference should also be made to measuring methods including so-called mechanical oscillators. The measurement principle in this regard is based on the viscosity difference between the working gas and the fluid. The viscosity of nitrogen thus depends on both the pressure and temperature but on the whole it is more than two orders of magnitude below the viscosity of hydraulic fluids in the entire range that is relevant for measurement application.

The mechanical oscillator (not shown) is situated within the fluid and its oscillation is attenuated accordingly by the fluid. The attenuation acting on the oscillator is proportional to the viscosity of the fluid.

The following mechanical oscillators may be considered in particular:
Oscillating quartz crystals such as a quartz crystal microbalance (QCM),
Surface acoustic wave sensors (SAW),
Micromechanical tuning forks,
Magnetoelastic films,
Mechanical-magnetic systems based on coils and soft magnetic oscillating elements.

QCM sensors, SAW sensors and micromechanical tuning forks can be used very well for determining the viscosity of hydraulic fluids and the measurement technique in this regard is very suitable for the present statement of object to detect unintentional overflow of media in hydraulic accumulators.

Furthermore, magnetoelastic films may be used in which the resonance frequency of a so-called magnetoelastic film changes with the ambient conditions, i.e., with the medium in which the film is situated. The film is preferably excited to resonance by means of a magnetic coil and the oscillation of the magnetoelastic film can be detected by means of a separate so-called pickup coil or by the exciter coil itself. This effect can also be used for differentiation as to whether the sensor film is in oil or gas. The mechanical oscillators in this regard can be assigned to the so-called physical measuring methods in the sense of the present subject matter of the patent application.

1. A media separating means, in particular a hydraulic accumulator (3) having a movable separating means (5) for separating two media (7, 9) which are accommodated in different media chambers (11, 13), characterized in that an overflow of at least one medium (7, 9) from one media chamber (11, 13) through the separating means (5) into the other media chamber (11, 13) containing the other medium (7, 9) can be detected by means of a measuring apparatus (15, 115).

2. The media separating means according to claim 1, characterized in that the measuring apparatus (15, 115) has at least one sensor element (17, 117) that detects the overflow using a
thermal and/or
chemical and/or
physical and/or
optical and/or
acoustic and/or
electric measuring method.

3. The media separating means according to claim 1, characterized in that the respective sensor element (17) has a connection (19) to a fixed location (21) in relation to at least one of the media chambers (11, 13), so that the sensor element (17) can be brought into contact with the medium (7, 9) that has overflowed in each position assumed by the separating means (5).

4. The media separating means according to claim 1, characterized in that the connection (19) is established by means of at least one flexible cable connection (23), and the respective cable (25) is connected at one end (29) to the respective sensor element (17) and is connected at its other end (30) to the fixed location (21) on parts of an accumulator housing (27), which at least partially borders the media chambers (11, 13).

5. The media separating means according to claim 1, characterized in that the end (30) of the respective cable connection (23) adjacent to the fixed location (21) is connected to a plug part (31) which preferably also comprises an electronic analyzer (33, 133).

6. The media separating means according to claim 1, characterized in that the hydraulic accumulator (3) is a bladder accumulator (35) having a flexible bladder (37) as the separating means (5) and the respective sensor element (17, 117) is arranged on the media chamber (11) designed as a gas side (39) within the accumulator housing (27), whose additional media chamber (13) forms the fluid side (41) of the hydraulic accumulator (3).

7. The measuring apparatus, also designed as a retrofitting or conversion kit for use in a media separating means (1) according to claim 1, consisting of at least
one sensor element (17, 117)
one cable connection (23, 123)
one electronic analyzer (33, 133) and preferably
one separating means (5).

8. The measuring method for operating the measuring apparatus (15) in a media separating means (1) according to claim 1, characterized in that, by means of a(n)
thermal measuring method, the thermal conductivity,
optical measuring method, the formation of a mist, luminescence or the reflection properties,
acoustic measuring method, the attenuation properties,
electric measuring method, the electrical conductivity,
chemical measuring method, a change in shape or a change in color and
physical measuring method, the behavior of mechanical oscillators is used for detection of an inadvertent media overflow from one media chamber (11, 13) to the other media chamber (13, 11) by way of the separating means (5).
